(19) United States
(12) Patent Application Publication
(10) Pub. No.: US 2015/0066195 A1
(43) Pub. Date: Mar. 5, 2015

(54) METHOD FOR POSITIONING A TOOL OF A MACHINE TOOL IN THE VISUAL FIELD OF A VISUAL SYSTEM AND RELATIVE MACHINE TOOL

(71) Applicant: Marposs Societa' Per Azioni, Bentivoglio (BO) (IT)

(72) Inventors: Stefano Passini, Bologna (IT); Roberto Bruni, Bologna (IT)

(73) Assignee: Marposs Societa' Per Azioni, Bentivoglio (BO) (IT)

(21) Appl. No.: 14/394,461

(22) PCT Filed: Apr. 18, 2013
(86) PCT No.: PCT/EP2013/058117

§ 371 Date: Oct. 14, 2014

(30) Foreign Application Priority Data
Apr. 20, 2012 (IT) BO 2012 A 000221

(51) Int. Cl. G05B 19/19

(52) U.S. Cl. CPC G05B 19/19; G05B 2219/50047
USPC 700/186

(57) ABSTRACT

A method for positioning a tool (3) mounted on a spindle (2) of a numerical control machine tool in the visual field (20) of a visual system (7) for measuring the tool, includes a step of moving (35) the rotating spindle along an axis (Z) from a reference position (Z0) towards a target position (Zobj) defined in the visual field, and a step of acquiring images of the visual field. The stop of the spindle movement along the axis is controlled as soon as an acquired image (IM1) reveals (36) that a determined portion (13) of the tool, for instance a tip, has entered the visual field. When the stop is controlled (37), an instant position (Z1) of the spindle is acquired (38) and a distance (POS) between the tip of the tool and the target position is measured (39). On the basis of such instant position and distance, a final position (Z2) is calculated (40), and the spindle is brought (42) to such final position. A preliminary step (31) during which the spindle and the tool are displaced of a certain amount towards the visual system, and/or a phase of fine positioning (44, 45, 46, 42) can be considered. A machine tool includes control units (4, 10) that implement the method for positioning.

### TECHNICAL FIELD

The present invention relates to a method for positioning a tool mounted on a spindle of a numerical control machine tool in the visual field of a visual system for measuring the tool.

The invention also concerns a machine tool that implements such method.

In particular, the present invention can advantageously, but not exclusively, be applied in a phase of displacing the tool preceding a process of automatically measuring the tool executed by means of the vision system, to which reference will be explicitly made in the specification without loss of generality.

### BACKGROUND ART

As is common knowledge, a numerical control machine tool includes a mechanical structure with a spindle which carries a tool for machining objects and makes it rotate, and an electronic control unit to precisely control the spindle displacements along three or more axes of movement and the tool rotational speed.

The tool of a machine tool has to be measured, also while it is rotating, to determine its effective dimensions once it is mounted on the spindle or to determine its wear after some working hours. For this purpose, the machine tools are equipped by an automatic measuring system which enables to measure the dimensions of the tool also while it is rotating.

A known automatic measuring system includes a laser source coupled to an optical receiver able to detect when the laser beam emitted by the source is interrupted by an object. The measuring of a tool dimension, for instance the difference of the tool length with respect to a nominal length, is made first bringing the spindle to a reference position then moving the spindle towards the laser beam along a direction transverse to the laser beam, the latter standing at a known distance from the reference position. When the tip of the tool interrupts the laser beam, more specifically when the tip interrupts a determined amount of the laser beam cross-section, the control unit records the spindle new position relative to the reference position. The dimension of the tool is evaluated according to the difference between the known distance and the recorded new position.

The measuring system based on the interruption of a laser beam has the inconvenience of having a measuring precision that is very much variable with the variation of both the dimensions of the tool tip, compared to the diameter of the laser beam cross-section, and the shape of the tool tip. Furthermore, such kind of measuring system may misinterpret any dirt (e.g. oil drops) possibly present on the tool tip as a part of the tool, so causing measuring mistakes.

An automatic measuring system is also known, which comprises a vision system, i.e. a light source providing an unfocused beam of radiations and a CCD camera to acquire images of the shadow profile of objects interposed between the light source and the camera. Such measuring system enables to overcome the inconveniences of the measuring system based on laser beam, that is it provides a measuring uniform precision and enables to recognise the dirt present on the tool tip. The measuring is carried out when the tool, rotating about its own axis, is placed in the visual field. To ensure the correct positioning of the tool, the rotating spindle is advanced for instance step by step, and at each step the position of the tip is real time checked directly from the acquired images.

The images acquisition time of the vision system, however, is quite long. In fact, it is considerably limited by the refresh rate of the camera and this constrains to choose a very low speed of displacement of the tool, otherwise the vision system could not be able to precisely frame the tool. This limits very much the minimum time required to perform the tool measuring. Moreover, when it is required to position the tool with high precision at a specific area of the visual field, the time needed becomes even longer because a further reduced speed of advancement or, alternatively, an iterative process of fine positioning is necessary.

### DISCLOSURE OF THE INVENTION

Object of the present invention is to provide a method for fast positioning a tool of a numerical control machine tool in the visual field of a visual system, such method being free from the previously described inconveniences and, concurrently, easily and cheaply implemented.

Object of the invention is also to realise a machine tool able to implement such positioning method.

According to the present invention, a method for positioning a tool mounted on a spindle of a numerical control machine tool in the visual field of a visual system for measuring the tool and a numerical control machine tool are provided, according to what is claimed in the attached claims.

### BRIEF DESCRIPTION OF THE DRAWINGS

The present invention is now described with reference to the attached sheets of drawings, given by way of non-limiting examples, wherein:

FIG. 1 shows a numerical control machine tool that implements a method according to a preferred embodiment of the present invention for positioning a tool mounted on the spindle;

FIGS. 2-5 schematically illustrate the spindle of the machine tool shown in FIG. 1 in four different steps of a positioning method according to the present invention;

FIG. 6 shows an enlarged detail of FIG. 5, in connection with an additional positioning phase according to a further preferred embodiment of the invention; and

FIG. 7 is a flowchart of the steps of a positioning method according to the present invention.

### BEST MODE FOR CARRYING OUT THE INVENTION

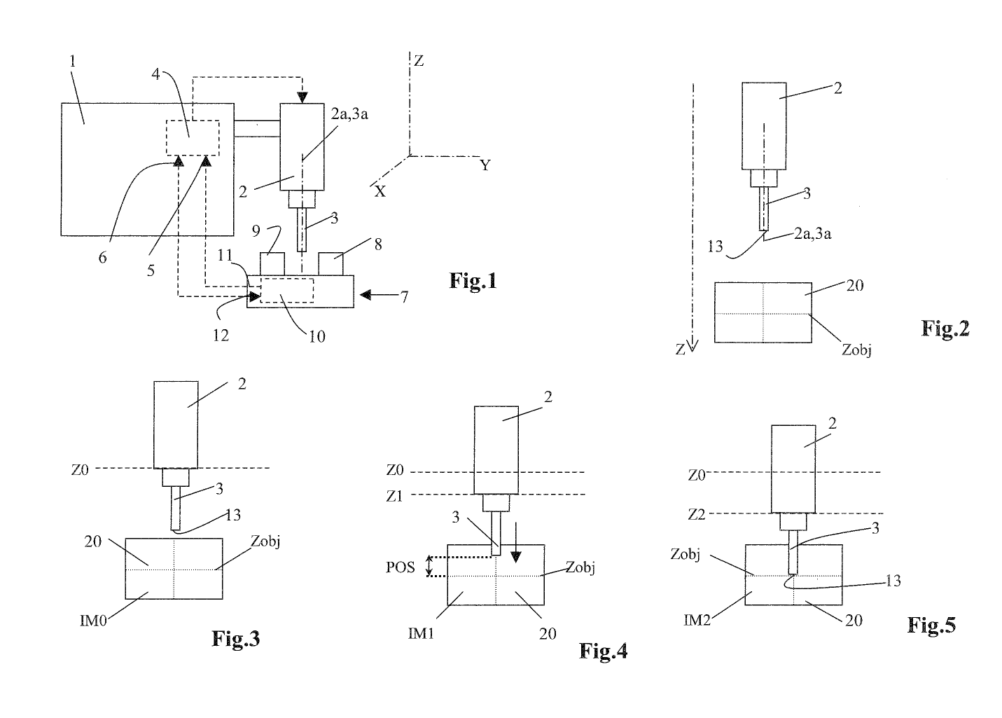

In FIG. 1, a numerical control (“NC”) machine tool is generically indicated, as a whole, with reference 1. The NC machine tool 1 comprises a spindle 2, on which a tool 3 is mounted, and a first electronic control unit 4 embodying the numerical control of the machine tool 1 that is able to control the rotational speed and movements of spindle 2 along at least one displacement axis. Typically the control unit 4 controls movements of the spindle 2 along the three Cartesian axes X, Y and Z by means of dedicated actuators, known per se hence not illustrated.

While the movements of the spindle 2 along the displacement axes are always started by means of machine code instructions being part of a program, such movements can be stopped under control of an external unit through a specific input 5 of the control unit 4, generally said “skip input”. The control unit 4 is also set up to record the position of the spindle 2 along the displacement axes, for instance when a control signal is received at the input 5. Besides, the control unit 4 includes a communication interface 6, e.g. a port of an Ethernet network.

The machine tool 1 is provided with a visual system 7 adapted to measure the dimensions of the tool 3 while the machine tool 1 keeps the spindle 2 rotating about its own rotation axis 2a. In particular, the visual system 7 comprises a light source 8 and an image sensor, typically a camera 9 placed in front of, and at a certain distance from, the light source 8 to acquire images of the shadow profile of the tool 3 when the latter is placed between the light source 8 and the camera 9 by means of the movements of the spindle 2 along the displacement axes. The light source 8 produces an unfocused light beam and the camera 9 is for instance a digital CCD camera.

The camera 9 features a visual field 20 that defines a measuring area for the tool 3. The measuring is performed by placing the rotating tool 3 in the visual field 20 of the camera 9, acquiring images of the visual field 20 and calculating the dimensions of the tool 3 from the acquired images.

According to the present invention, the visual system 7 comprises a second electronic control unit 10 connected to the control unit 4 to send controls to and exchange data with the control unit 4. In the schematic diagram of FIG. 1, the control unit 10 is shown as physically integrated into a frame carrying the light source 8 and the camera 9, but it can be realised as a physically separated element. In particular, the control unit 10 comprises an output 11 connectable to the input 5 of the control unit 4 and a communication port 12 connectable to the communication interface 6 of the control unit 4. The control units 4 and are programmed in order to implement a method for positioning the tool 3 in the visual field 20 of the visual system 7, more specifically a method according to the present invention that is described hereafter with reference to the figures from 2 to 5.

FIG. 2 schematically illustrates the spindle 2 in a starting position, or zero-position, such that the tool 3, which is mounted on the spindle 2, is totally out of the visual field 20 of the camera 9 (the latter not being shown in FIGS. 2 to 5). The visual field 20 has, for instance, a first side being between 0.3 and 0.5 mm long and a second side being between 0.2 and 0.4 mm long. The tool 3 schematically illustrated by way of example in the figures, defines a longitudinal tool axis 3a. The spindle 2 clamps the tool 3 so that the tool axis 3a is substantially superimposed to the rotation axis 2a. During the positioning of the tool 3 in the visual field 20 and the following operations for measuring the tool 3, the spindle 2 is kept rotating about the axis 2a.

According to the present invention, a target position for a determined portion of the tool 3, in particular a tip 13, is defined in the visual field 20. The target position is indicated in the figures as a vertical height Zobj and is typically centred in the visual field 20 along the direction of the axis Z, because the central portion of the visual field 20 is the portion which, usually, ensures the best performance.

The flowchart of FIG. 7 shows the steps of a positioning method according to the present invention, including also an additional optional phase of “fine positioning”. The steps indicated by the blocks of the flowchart are referred to in the description that follows.

When the positioning procedure starts (block 30 of FIG. 7), in a preliminary phase (block 31), the control unit 4, while keeping the spindle 2 rotating, controls a preliminary displacement of the spindle 2 along the axis Z starting from the zero-position and towards the visual system 7. The preliminary displacement—whose size depends on an estimate of a dimension L of the tool 3 along the direction of the axis Z—aims to arrange the tip 13 of the tool 3 within the visual field 20. The dimension L of the tool 3 is previously estimated, for instance during a calibration procedure, and stored in the control unit 4 of the machine tool 1. Such an estimate can be manually performed by an operator and stored in a suitable table of the control unit 4. At the end of this preliminary phase, the spindle 2 is located in a reference position Z0 along the vertical displacement axis Z, at which the determined portion, more specifically the tip 13, of the tool 3 may be located within the visual field 20, below it (with reference to the arrangement shown in the figures) after having passed through such visual field 20, or above it, in an configuration corresponding to that of FIG. 3, instance that occurs when the dimension L is overestimated. A preliminary image IM0 of the visual field 20 is acquired (block 32) through the visual system 7 in correspondence of the reference position Z0 of the spindle 2, and a checking step is carried out (blocks 33 and 34) to detect which of the three occurrences is verified. More specifically, it is checked whether the determined portion (the tip) 13 of the tool 3 is within the visual field 20, and a negative outcome (output N from block 33) is provided if the tip 13 is below or above such visual field 20.

Supposing that, in the reference position Z0 of the spindle 2, the occurrence schematically illustrated in FIG. 3 is verified, in which the tool 3 is totally out of, more specifically above, the visual field 20—occurrence verified and detected (output Y from block 34) by the control unit 10 that acquires the preliminary image IM0—the control unit 4, while keeping the spindle 2 rotating, controls a continuous first movement of the spindle 2 along the axis Z (block 35), starting from the reference position Z0 and in a first direction that moves the tip 13 of the tool 3 towards the target position Zobj. During this first movement of the spindle 2 the visual system 7 acquires images of the visual field 20. In the example of FIG. 3, the spindle 2 continuous first movement is a downward vertical movement.

The spindle 2 first movement along the axis Z is stopped as soon as the visual system 7 detects, on the basis of one of the acquired images, that the tip 13 of the tool 3 has entered the visual field 20 (output Y from block 36). Such instance is illustrated in FIG. 4. More specifically, the control unit 10 elaborates the images acquired one by one by the camera 9 to look for an acquired image, hereafter referred to as IM1, in which the shadow profile of at least a portion, more specifically the tip 13, of the tool 3 is visible. In other words, the visual system 7 works with a so-called “outside/inside” approach of the tool 3.

As soon as the control unit 10 detects the image IM1 (while the spindle is advancing along the axis Z, as indicated by an arrow in FIG. 4), it supplies a stop control at the output 11 (block 37) to order the control unit 4, by sending a control signal to the input 5, to stop the spindle 2 movement, in particular to stop its advancement. Once the stop control has been received, the control unit 4 starts the stop process of the spindle 2 advancement (block 38), and acquires and records a corresponding instant position Z1 of the spindle 2. In particular, the recorded instant position Z1 is the position of the rotating spindle 2 at the instant the control unit 4 orders the stop of the spindle 2 movement along the axis Z, that is, as earlier said, it starts the stop process.

At this stage, the control unit 10 measures, on the basis of the image IM1, a first distance POS between the position of the tip 13 and the target position Zobj (block 39). The control unit 4 demands to and attains from the control unit 10—through the connection comprising the communication interface 6 and the communication port 12—the value of such first distance POS, and calculates a first final position Z2 (block 40) for the spindle 2 as the algebraic sum of the instant position Z1 of the spindle 2 and the distance POS. The first distance POS has a positive value if the tip 13 has not passed the target position Zobj (as in the arrangement of FIG. 4) and has a negative value if the tip 13 has passed the target position Zobj.

After the real stop of the spindle 2 advancement along the axis Z (output Y from test block 41), at which the tip 13 of the tool 3 may be within the visual field 20 or may have passed through and gone beyond it, the control unit 4 controls the spindle 2 movement along the axis Z to bring the spindle 2 directly to such first final position Z2 (block 42 and FIG. 5). The displacement carried out by the spindle 2, hence by the tip 13, relative to the instant position Z1 is then the distance POS, so the tip 13 is substantially brought to the target position Zobj, as illustrated in FIG. 5.

It may be considered that the real position of the tip 13 when the spindle 2 is actually stopped along the axis Z is not the position showed by the image IM1 (FIG. 4), for the following reasons:
a time interval ΔT1 elapses between the acquisition instant of the image IM1 and the record instant of the instant position Z1 corresponding to the start of the stop process of the spindle 2 advancement. Such time interval ΔT1 is due to delays depending on features of the visual system 7 and control units 4 and 10 circuitry, so it is variable and not negligible compared to the travel time of the tip 13 in the visual field 20; and
the spindle 2 is subjected to a deceleration along the axis Z in a time interval ΔT2, extending from the instant at which the control unit 4 instructs the spindle 2 to stop its advancement to the instant at which the spindle 2 advancement really stops, which is affected by a certain variability.

In view of the above consideration and according to a preferred embodiment of the present invention, the method includes, in addition to the main positioning phase described above, an optional phase of “fine positioning” (output Y of test block 43 indicating that the fine positioning is required) during which the visual system 7 acquires a first further image IM2 of the visual field 20 (block 44) when the position along the axis Z of the spindle 2, always rotating, is fixed in the first final position Z2 of FIG. 5. In particular, the control unit 4 demands to and attains from the control unit 10—through the connection comprising the communication interface 6 and the communication port 12—the value of a second distance POS2 between the tip 13 of the tool 3 and the target position Zobj along the axis Z, attained (block 45) on the basis of the first further image IM2. The control unit 4 calculates (block 46) a second final position for the spindle 2 as algebraic sum of the first final position Z2 and said second distance POS2, and controls the spindle 2 movement along the axis Z to bring the spindle 2 directly to the second final position (block 42, as in the main positioning phase). Thus, the final positioning error due to the time intervals ΔT1 and ΔT2 is adjusted.

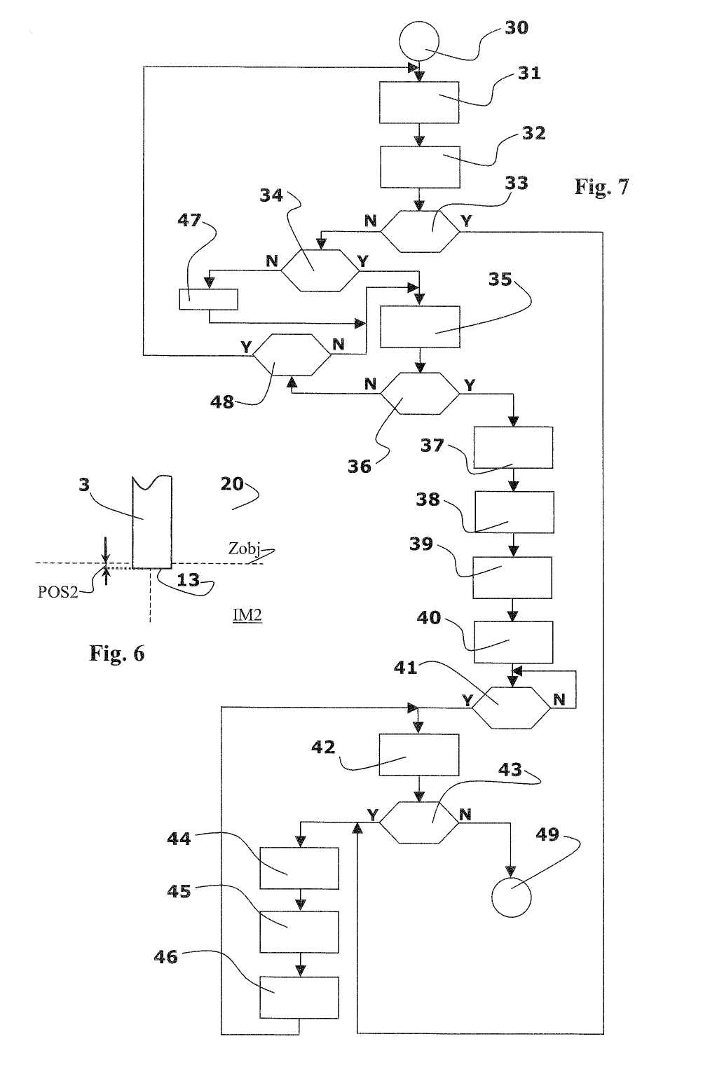

It is pointed out that the second distance POS2 is shown in FIG. 6, that is an enlarged detail of FIG. 5, more specifically of a central area of the first further image IM2 of the visual field 20. Additional drawings showing the second final position reached by means of the additional fine positioning phase are considered unnecessary, since such additional phase takes place in a way substantially identical to what is described with reference to the first positioning phase (FIGS. 4 and 5).

As previously mentioned, at the end of the preliminary displacement of the spindle 2 along the axis Z, at the reference position Z0 of FIG. 2, the determined portion, more specifically the tip 13, of the tool 3 may be located below (referring to the disposition showed in the figures) the visual field 20 (output N from block 34), owing to an underestimation of the dimension L of the tool 3 along the direction of the axis Z. This occurrence (that is not shown in the drawings) is detected by the control unit 10 that acquires the preliminary image IM0 and verifies that a portion of the tool 3 different from the tip 13 is placed in the visual field 20 (blocks 33 and 34). Also in this case, a method for positioning according to the present invention provides that the control unit 4, while keeping the spindle 2 rotating, controls a continuous first movement of the spindle 2 along the axis Z, starting from the reference position Z0 and in a direction that moves the tip 13 of the tool 3 towards the target position Zobj. In this case, the first movement of the spindle 2 is in a second direction opposed to the first one, i.e. upwards referring to the disposition of the figures, with an “inside/outside” approach. Block 47 in FIG. 7 indicates that the direction of movement is inverted. Also in this case, the first movement of the spindle 2 along the axis Z (block 35) is stopped as soon as the visual system 7 detects (block 36), on the basis of one of the acquired images, that the tip 13 of the tool 3 has entered the visual field 20, and the steps that follow are the same ones already described with reference to the “outside/inside” approach.

When in the above described preliminary phase, that is at the end of the preliminary displacement of the spindle 2 along the axis Z, at the reference position Z0 of FIG. 2, it is detected (output Y from block 33) that the tip 13 of the tool 3 is placed within the visual field 20 (thanks to a substantially correct estimate of the tool 3 dimension L along the direction of the axis Z), the phases of control of the first movement of the spindle 2 and acquisition—during such movement—of the visual field 20 images with later processing and controlling are not needed, and only one cycle of “fine positioning” like that previously described (blocks 44, 45, 46 and 42) is carried out.

If the speed of movement of the spindle 2 along the axis Z is too high, it may happen that the acquired image IM1 including the tip 13 of the tool 3 cannot be detected, for the tip 13 has gone beyond the visual field 20. Thus, the positioning cycle is stopped according to a security process controlled by the control unit 4 and indicated in FIG. 7 with test block 48, after which the spindle 2 is for instance brought back to the reference position Z0, and the positioning cycle is started again.

Once the positioning of the tool 3 is carried out by means of a method according to the invention, as thus far described, the tool 3 is subjected to cycles of dimension and/or shape checking through the visual system 7, cycles per se known and not discussed in here. Block 49 in FIG. 7 indicates the end of the positioning phase.

From the above description, it is clear that the positioning method of the invention can be applied also in cases where the tool 3 enters the visual field 20 by means of movements along different displacement axes, e.g. the axis X or the axis Y. In this cases, the target position is represented by an horizontal location along the relative axe X or Y.

Moreover, the positioning method of the invention can be used for positioning, in the visual field 20 of the visual system 7, rotating tools having irregular shape and/or dimensions greatly larger than those of the visual field 20, their rotation axis standing out of the visual field 20. In these cases, the aim of the positioning method is moving the spindle 2 in such way as to bring a determined portion, typically an edge point, of the tool in correspondence of the target position in the visual field 20.

The main advantage of the above described method for positioning a tool is getting a high speed of positioning, since only the processing of few images of the tool is required. At the same time, the method enables to get a highly precise positioning, since the final position of the spindle is adjusted according to the displacements between the tip of the stationary tool and the target position of the visual field directly calculated from the processed images. This is even more true when the additional fine positioning phase is carried out. Moreover, the dimensions of the tool in the machine have not to be necessarily known a priori.

Variations to what described and illustrated until now by way of non limiting example are possible, for instance as regards the operation of the control units 4 and 10, which can be integrated in a single unit or exchange between them some operations. For instance, it can be the control unit 10 of the visual system 7 that demands to and receives from the control unit 4 information about the position of the spindle (Z0, Z1, Z2) and processes it together with the values of the distances POS, POS2.

1. A method for positioning a tool mounted on a spindle of a numerical control machine tool in the visual field of a visual system for measuring the tool, the method including the steps of:
defining, in said visual field, a target position for a determined portion of the tool;
controlling a first movement of the spindle along at least one displacement axis starting from a reference position and in such a way as to move said determined portion of the tool towards said target position, while the visual system acquires images of the visual field;
controlling the stop of the first movement of the spindle along the displacement axis as soon as the visual system detects, on the basis of an acquired image, that said determined portion of the tool has entered said visual field;
acquiring an instant position of the spindle when the stop is controlled;
measuring, on the basis of said acquired image in which said determined portion of the tool is visible, a first distance between said determined portion of the tool and the target position along the displacement axis;
calculating a first final position for the spindle as the algebraic sum of said instant position of the spindle and said first distance; and
moving the spindle along the displacement axis to bring the spindle to the first final position.

2. The method according to claim 1 and further including the following steps:
acquiring, by means of said visual system, a first further image of the visual field when the spindle is stationary in said first final position;
measuring, on the basis of said first further image, a second distance between said determined portion of the tool and the target position along the displacement axis;
calculating a second final position for the spindle as the algebraic sum of the first final position and said second distance; and
moving the spindle along the displacement axis to bring the spindle to said second final position.

3. The method according to claim 1 and further including a preliminary phase with the following steps:
estimating a dimension of said tool along said displacement axis;
actuating a preliminary displacement of the spindle along the displacement axis towards the visual system, the size of the displacement depending on the estimated dimension of the tool;
acquiring, by means of said visual system, a preliminary image of the visual field at said reference position, when the spindle is stationary after said preliminary displacement;
checking, on the basis of said preliminary image, whether said determined portion of the tool is within said visual field; and
proceeding with the step of controlling a first movement of the spindle only if the preceding checking step has a negative outcome.

4. The method according to claim 3, wherein if the checking step made on the basis of said preliminary image shows that the tool is completely outside said visual field, the step of controlling the first movement of the spindle is carried out in a first direction.

5. The method according to claim 3, wherein if the checking step made on the basis of said preliminary image shows that a portion of the tool different from said determined portion is within said visual field, the step of controlling the first movement of the spindle is carried out in a second direction.

6. The method according to claim 1, wherein said machine tool includes a first electronic control unit and said visual system comprises a second electronic control unit connected thereto to communicate with the first control unit; the movement and the stop of said spindle along said displacement axis being controlled by the first control unit; the record of said instant position being carried out by said first control unit; the measurement of said first distance being carried out by the second control unit.

7. The method according to claim 6, wherein the calculation of said first final position is carried out by the first control unit.

8. The method according to claim 1, wherein said visual system includes a light source and an image sensor placed in front of and at a certain distance from the light source to acquire images of the shadow profile of the tool, when the latter is positioned between the light source and the image sensor.

9. The method according to claim 1, wherein the spindle is moved along at least one displacement axis while it continues to rotate about the rotation axis.

10. A numerical control machine tool comprising a spindle with a tool mounted thereon, a first electronic control unit, which is adapted to control the rotational speed of the spindle and the movements of the spindle along at least one displacement axis and to record the position of the spindle along said displacement axis, and a visual system for measuring the rotating tool; wherein the visual system comprises a second electronic control unit thereto to communicate with the first control unit, and the two control units are set to implement the method according to claim 1.

11. The method according to claim 2 and further including a preliminary phase with the following steps:
estimating a dimension of said tool along said displacement axis;
actuating a preliminary displacement of the spindle along the displacement axis towards the visual system, the size of the displacement depending on the estimated dimension of the tool;
acquiring, by means of said visual system, a preliminary image of the visual field at said reference position, when the spindle is stationary after said preliminary displacement;
checking, on the basis of said preliminary image, whether said determined portion of the tool is within said visual field; and
proceeding with the step of controlling a first movement of the spindle only if the preceding checking step has a negative outcome.

12. The method according to claim 11, wherein if the checking step made on the basis of said preliminary image shows that the tool is completely outside said visual field, the step of controlling the first movement of the spindle is carried out in a first direction.

13. The method according to claim 12, wherein if the checking step made on the basis of said preliminary image shows that a portion of the tool different from said determined portion is within said visual field, the step of controlling the first movement of the spindle is carried out in a second direction.
